(19) United States
(12) Patent Application Publication
(10) Pub. No.: US 2026/0188844 A1
(43) Pub. Date: Jul. 2, 2026

(54) ELECTRODE ASSEMBLY AND SECONDARY BATTERY INCLUDING ELECTRODE ASSEMBLY

(71) Applicant: SAMSUNG SDI CO., LTD., Yongin-si (KR)

(72) Inventor: Hyunwoo KIM, Yongin-si (KR)

(21) Appl. No.: 19/281,965

(22) Filed: Jul. 28, 2025

(30) Foreign Application Priority Data
Dec. 27, 2024 (KR) 10-2024-0198391

(51) Int. Cl. H01M 50/46; H01M 10/44; H01M 50/284

(52) U.S. Cl. CPC H01M 50/46; H01M 10/44; H01M 50/284

(57) ABSTRACT

The electrode assembly includes a parallel portion including one or more first unit cells being stacked; and a serial portion including one or more second unit cells being stacked, wherein each of the one or more first unit cells includes: a first separator; a first positive electrode active material portion disposed on one surface of the first separator; a first negative electrode active material portion disposed on the other surface of the first separator; a first substrate disposed on the first positive electrode active material portion; and a second substrate disposed on the first negative electrode active material portion, wherein the one or more first unit cells being stacked share either the first substrate having the first positive electrode active material portion disposed on both surfaces of the first substrate, or the second substrate having the first negative electrode active material portion disposed on both surfaces of the second substrate.

### CROSS-REFERENCE TO RELATED APPLICATION

The present application claims priority to and the benefit of Korean Application No. 10-2024-0198391, filed on Dec. 27, 2024, in the Korean Intellectual Property Office, the entire disclosure of which is incorporated by reference herein.

### BACKGROUND

### Field

The present disclosure relates to an electrode assembly and a secondary battery including the electrode assembly.

### Description of the Related Art

While primary batteries are not designed to be (re)charged, secondary (also known as rechargeable) batteries are batteries that are designed to be discharged and recharged. Among secondary batteries, low-capacity secondary batteries are widely used in portable, small electronic devices, such as smart phones, feature phones, notebook computers, digital cameras, and camcorders, while high-capacity secondary batteries are widely used as power sources for driving motors in hybrid vehicles and electric vehicles, as well as for storing power (e.g., home and/or utility scale power storage). A secondary battery generally includes an electrode assembly including a positive electrode and a negative electrode, a case accommodating both electrodes, and electrode terminals connected to the electrode assembly.

The voltage of a secondary battery may vary according to the state of charge (SOC). As charging of the battery progresses, the SOC increases, and the voltage of the battery may increase. As the voltage increases, the risk of deterioration increases due to chemical reactions between the electrode and the electrolyte being intensified. Accordingly, there is a need to develop a secondary battery that is stable under an increased voltage environment.

This Background section is for the general understanding of the background of the present disclosure, and therefore, it may contain information that does not constitute related (or prior) art.

### SUMMARY

These and other aspects and features of the present disclosure will be described in or will be apparent from the following description of embodiments of the present disclosure.

Embodiments of the present disclosure provide a battery electrode assembly including a parallel portion formed by stacking one or more first unit cells, and a serial portion formed by stacking one or more second unit cells, wherein each of the one or more first unit cells may include a first separator, a first positive electrode active material portion disposed on one surface of the first separator, a first negative electrode active material portion disposed on the other surface of the first separator, a first substrate disposed on the first positive electrode active material portion, and a second substrate disposed on the first negative electrode active material portion, and the stacked one or more first unit cells share either the first substrate having the first positive electrode active material portion disposed on both surfaces of the first substrate or the second substrate having the first negative electrode active material portions disposed on both surfaces of the second substrate, wherein each of the one or more second unit cells may include a second separator, a second positive electrode active material portion disposed on one surface of the second separator, a second negative electrode active material portion disposed on the other surface of the second separator, and a third substrate respectively disposed on the second positive electrode active material portion and the second negative electrode active material portion, and the stacked one or more second unit cells share the third substrate having the second positive electrode active material portion disposed on one surface of the third substrate and the second negative electrode active material portion disposed on the other surface of the third substrate, and wherein the serial portion and the parallel portion share either the first substrate having the first positive electrode active material portion disposed on one surface of the first substrate and the second positive electrode active material portion disposed on the other surface of the first substrate, or the second substrate having the first negative electrode active material portion disposed on one surface of the second substrate and the second negative electrode active material portion disposed on the other surface.

Embodiments of the present disclosure provide a battery electrode assembly including: a parallel portion including one or more first unit cells being stacked; and a serial portion including one or more second unit cells being stacked, wherein each of the one or more first unit cells includes: a first separator; a first positive electrode active material portion disposed on one surface of the first separator; a first negative electrode active material portion disposed on the other surface of the first separator; a first substrate disposed on the first positive electrode active material portion; and a second substrate disposed on the first negative electrode active material portion, wherein the one or more first unit cells being stacked share either the first substrate having the first positive electrode active material portion disposed on both surfaces of the first substrate, or the second substrate having the first negative electrode active material portion disposed on both surfaces of the second substrate, wherein each of the one or more second unit cells includes: a second separator; a second positive electrode active material portion disposed on one surface of the second separator; a second negative electrode active material portion disposed on the other surface of the second separator; and a third substrate disposed on the second positive electrode active material portion and the second negative electrode active material portion, and wherein the one or more second unit cells being stacked share the third substrate having the second positive electrode active material portion disposed on one surface of the third substrate and the second negative electrode active material portion disposed on the other surface of the third substrate, and wherein the serial portion and the parallel portion share either the first substrate having the first positive electrode active material portion disposed on one surface of the first substrate and the second positive electrode active material portion disposed on the other surface of the first substrate, or the second substrate having the first negative electrode active material portion disposed on one surface of the second substrate and the second negative electrode active material portion disposed on the other surface of the second substrate.

In some embodiments, the battery electrode assembly may further include a positive electrode tab disposed on the first substrate and a negative electrode tab disposed on the second substrate.

In some embodiments, a second positive electrode active material portion is disposed on an inner surface of the third substrate positioned at an outermost side of the serial portion, wherein an additional positive electrode tab is disposed on the third substrate positioned at the outermost side.

In some embodiments, a second negative electrode active material portion is disposed on an inner surface of the third substrate positioned at an outermost side of the serial portion, and wherein an additional negative electrode tab is disposed on the third substrate positioned at the outermost side.

In some embodiments, a ratio (C1/C2) of a charge capacity (C1) of the serial portion to a total charge capacity (C2) of the serial portion and the parallel portion is from about 0.05 to about 0.25.

Embodiments of the present disclosure provide a secondary battery including an electrode assembly, and a case accommodating the electrode assembly, wherein the case includes a positive electrode terminal and a negative electrode terminal, wherein the electrode assembly may include a parallel portion formed by stacking one or more first unit cells, and a serial portion formed by stacking one or more second unit cells, wherein each of the one or more first unit cells may include a first separator, a first positive electrode active material portion disposed on one surface of the first separator, a first negative electrode active material portion disposed on the other surface of the first separator, a first substrate disposed on the first positive electrode active material portion, and a second substrate disposed on the first negative electrode active material portion, and the stacked one or more first unit cells share either the first substrate having the first positive electrode active material portion disposed on both surfaces of the first substrate or the second substrate having the first negative electrode active material portions disposed on both surfaces of the second substrate, wherein each of the one or more second unit cells may include a second separator, a second positive electrode active material portion disposed on one surface of the second separator, a second negative electrode active material portion disposed on the other surface of the second separator, and a third substrate respectively disposed on the second positive electrode active material portion and the second negative electrode active material portion, and the stacked one or more second unit cells share the third substrate having the second positive electrode active material portion disposed on one surface of the third substrate and the second negative electrode active material portion disposed on the other surface of the third substrate, and wherein the serial portion and the parallel portion share either the first substrate having the first positive electrode active material portion disposed on one surface of the first substrate and the second positive electrode active material portion disposed on the other surface of the first substrate, or the second substrate having the first negative electrode active material portion disposed on one surface of the second substrate and the second negative electrode active material portion disposed on the other surface of the second substrate.

Embodiments of the present disclosure provide a secondary battery including an electrode assembly, and a case accommodating the electrode assembly, wherein the case includes a positive electrode terminal and a negative electrode terminal, wherein the electrode assembly includes: a parallel portion including one or more first unit cells being stacked; and a serial portion including one or more second unit cells being stacked, wherein each of the one or more first unit cells includes: a first separator; a first positive electrode active material portion disposed on one surface of the first separator; a first negative electrode active material portion disposed on the other surface of the first separator; a first substrate disposed on the first positive electrode active material portion; and a second substrate disposed on the first negative electrode active material portion, wherein the one or more first unit cells being stacked share either the first substrate having the first positive electrode active material portion disposed on both surfaces of the first substrate, or the second substrate having the first negative electrode active material portion disposed on both surfaces of the second substrate, wherein each of the one or more second unit cells includes: a second separator; a second positive electrode active material portion disposed on one surface of the second separator; a second negative electrode active material portion disposed on the other surface of the second separator; and a third substrate disposed on the second positive electrode active material portion and the second negative electrode active material portion, and wherein the one or more second unit cells being stacked share the third substrate having the second positive electrode active material portion disposed on one surface of the third substrate and the second negative electrode active material portion disposed on the other surface of the third substrate, and wherein the serial portion and the parallel portion share either the first substrate having the first positive electrode active material portion disposed on one surface of the first substrate and the second positive electrode active material portion disposed on the other surface of the first substrate, or the second substrate having the first negative electrode active material portion disposed on one surface of the second substrate and the second negative electrode active material portion disposed on the other surface of the second substrate.

In some embodiments, the secondary battery further includes a positive electrode tab disposed on the first substrate, and a negative electrode tab disposed on the second substrate.

In some embodiments, the electrode assembly further includes a positive electrode tab disposed on the first substrate, and a negative electrode tab disposed on the second substrate.

In some embodiments, a second positive electrode active material portion is disposed on an inner surface of the third substrate positioned at an outermost side of the serial portion, and wherein an additional positive electrode tab is disposed on the third substrate positioned the outermost side.

In some embodiments, the secondary battery further includes a control circuit configured to connect the positive electrode terminal to at least one of the positive electrode tab or the additional positive electrode tab, and to connect the negative electrode terminal to the negative electrode tab.

In some embodiments, the control circuit is further configured to connect the positive electrode terminal to the positive electrode tab until an SOC (State of Charge) of the secondary battery reaches a predetermined reference SOC, and wherein the reference SOC is from 80% to 130%.

In some embodiments, the control circuit is configured to connect the positive electrode terminal to the positive electrode tab until a state of charge (SOC) of the secondary battery reaches a reference SOC, and wherein the reference SOC is from about 80% to about 130% based on the SOC of the secondary battery at a fully charged state.

In some embodiments, the control circuit is further configured to connect the positive electrode terminal to the additional positive electrode tab after the SOC of the secondary battery reaches a predetermined reference SOC, and wherein the reference SOC is from 80% to 130%.

In some embodiments, the control circuit is configured to connect the positive electrode terminal to the additional positive electrode tab upon a state of charge (SOC) of the secondary battery reaching a reference SOC, and wherein the reference SOC is from about 80% to about 130% based on the SOC of the secondary battery at a fully charged state.

In some embodiments, the control circuit is further configured to connect the positive electrode terminal to the positive electrode tab until an internal voltage of the secondary battery reaches a predetermined cut-off voltage, and wherein the cut-off voltage is from 4.25V to 4.3V.

In some embodiments, the control circuit is configured to connect the positive electrode terminal to the positive electrode tab until an internal voltage of the secondary battery reaches a cut-off voltage, and wherein the cut-off voltage is from about 4.25V to about 4.3V.

In some embodiments, the control circuit is further configured to connect the positive electrode terminal to the additional positive electrode tab after the internal voltage of the secondary battery reaches a predetermined cut-off voltage, and wherein the cut-off voltage is from 4.25V to 4.3V.

In some embodiments, the control circuit is configured to connect the positive electrode terminal to the additional positive electrode tab upon an internal voltage of the secondary battery reaching a cut-off voltage, and wherein the cut-off voltage is from about 4.25V to about 4.3V.

In some embodiments, a second negative electrode active material portion is disposed on an inner surface of the third substrate positioned at an outermost side of the serial portion, and wherein an additional negative electrode tab is disposed on the third substrate positioned at the outermost side.

In some embodiments, the secondary battery further includes a control circuit configured to connect the positive electrode terminal to the positive electrode tab, and connect the negative electrode terminal to at least one of the negative electrode tab or the additional negative electrode tab.

In some embodiments, the control circuit is further configured to connect the negative electrode terminal to the negative electrode tab until an SOC of the secondary battery reaches a predetermined reference SOC, and wherein the reference SOC is from 80% to 130%.

In some embodiments, the control circuit is configured to connect the negative electrode terminal to the negative electrode tab until a state of charge (SOC) of the secondary battery reaches a reference SOC, and wherein the reference SOC is from about 80% to about 130% based on the SOC of the secondary battery at a fully charged state

In some embodiments, the control circuit is further configured to connect the negative electrode terminal to the additional negative electrode tab after the SOC of the secondary battery reaches a predetermined reference SOC, and wherein the reference SOC is from 80% to 130%.

In some embodiments, the control circuit is configured to connect the negative electrode terminal to the additional negative electrode tab upon a state of charge (SOC) of the secondary battery reaching a reference SOC, and wherein the reference SOC is from about 80% to about 130% based on the SOC of the secondary battery at a fully charged state.

In some embodiments, the control circuit is further configured to connect the negative electrode terminal to the negative electrode tab until an internal voltage of the secondary battery reaches a predetermined cut-off voltage, and wherein the cut-off voltage is from 4.25V to 4.3V.

In some embodiments, the control circuit is configured to connect the negative electrode terminal to the negative electrode tab until an internal voltage of the secondary battery reaches a cut-off voltage, and wherein the cut-off voltage is from about 4.25V to about 4.3V.

In some embodiments, the control circuit is further configured to connect the negative electrode terminal to the additional negative electrode tab after the internal voltage of the secondary battery reaches a predetermined cut-off voltage, and wherein the cut-off voltage is from 4.25V to 4.3V.

In some embodiments, the control circuit is configured to connect the negative electrode terminal to the additional negative electrode tab upon an internal voltage of the secondary battery reaching a cut-off voltage, and wherein the cut-off voltage is from about 4.25V to about 4.3V.

In some embodiments, a ratio (C1/C2) of a charge capacity (C1) of the serial portion to a total charge capacity (C2) of the serial portion and the parallel portion is from about 0.05 to about 0.25.

According to some embodiments of the present disclosure, by including a parallel portion and a serial portion inside the battery, it is possible to provide an additional positive electrode tab or an additional negative electrode tab. Under such a structure, as the battery is charged, if the SOC increases and the voltage inside the battery rises, the additional positive electrode tab or additional negative electrode tab may be connected so that the elevated voltage flows to the additional positive electrode tab or the additional negative electrode tab, thereby reducing the degree of battery deterioration.

According to some embodiments of the present disclosure, by including a control circuit that connects at least one of the positive electrode tab or additional positive electrode tab to the positive electrode terminal, and connects at least one of the negative electrode tab or additional negative electrode tab to the negative electrode terminal, it is possible to open or close the circuit according to the voltage inside the battery. Under such a structure, the circuit may be switched to an optimal connection method by responding to the voltage inside the battery.

According to some embodiments of the present disclosure, by including a serial portion of a certain ratio based on the total charge capacity of the serial portion and the parallel portion in the electrode assembly, deterioration may be reduced and the battery's lifespan may be increased while minimizing the reduction in battery capacity. Under such a structure, the battery may be used over a long term.

### BRIEF DESCRIPTION OF DRAWINGS

The drawings illustrate embodiments of the present disclosure, and further describe aspects and features of the present disclosure along with the detailed description of the present disclosure. Thus, the present disclosure should not be construed as being limited to the drawings.

FIG. 1 is a cross-sectional view illustrating an electrode assembly according to embodiments of the present disclosure.

FIG. 2 is a cross-sectional view illustrating a serial portion according to embodiments of the present disclosure.

FIG. 3 is a cross-sectional view illustrating an electrode assembly including an additional positive electrode tab according to embodiments of the present disclosure.

FIG. 4 is a cross-sectional view illustrating an electrode assembly including an additional negative electrode tab according to embodiments of the present disclosure.

FIG. 5 is a cross-sectional view illustrating a plurality of serial portions being stacked according to embodiments of the present disclosure.

FIG. 6 shows a control circuit being connected according to embodiments of the present disclosure.

FIG. 7 shows a control circuit being connected to the electrode assembly until the SOC of the secondary battery reaches a predetermined reference SOC according to embodiments of the present disclosure.

FIG. 8 shows a control circuit being connected to the electrode assembly after the SOC of the secondary battery reaches the predetermined reference SOC according to embodiments of the present disclosure.

FIG. 9 shows a control circuit being connected to the electrode assembly until an internal voltage of the secondary battery reaches a predetermined cut-off voltage according to embodiments of the present disclosure.

FIG. 10 shows a control circuit being connected to the electrode assembly after the internal voltage of the secondary battery reaches the predetermined cut-off voltage according to embodiments of the present disclosure.

### DETAILED DESCRIPTION

Hereinafter, embodiments of the present disclosure will be described, in detail, with reference to the accompanying drawings. The terms or words used in this specification and claims should not be construed as being limited to the usual or dictionary meaning and should be interpreted as meaning and concept consistent with the technical idea of the present disclosure based on the principle that the inventor can be his/her own lexicographer to appropriately define the concept of the term to explain his/her invention in the best way.

The embodiments described in this specification and the configurations shown in the drawings are only some of the embodiments of the present disclosure and do not represent all of the technical ideas, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

To facilitate understanding of the disclosure, the attached drawings are not drawn to actual scale and the dimensions of some components may be exaggerated. Furthermore, the same reference numbers may be assigned to the same components in different embodiments. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C,” “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all subranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation recognized in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked,” or “connected” to each other, or another component may be interposed between the components.

Throughout the specification, when “A and/or B” is stated, it means A, B, or A and B, unless otherwise stated. That is, “and/or” includes any or all combinations of a plurality of items enumerated. When “C to D” is stated, it means C or more and D or less, unless otherwise specified.

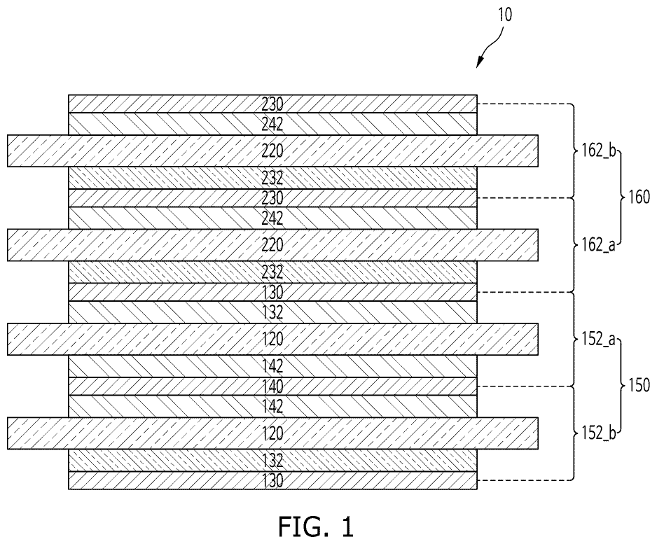

FIG. 1 is a cross-sectional view illustrating an electrode assembly 10.

Referring to FIG. 1, the electrode assembly 10 may include a parallel portion 150 and a serial portion 160. For example, the ratio (C1/C2) of the charge capacity (C1) of the serial portion 160 to the total charge capacity (C2) of the parallel portion 150 and the serial portion 160 may be about 0.05 to about 0.25, and the compositional ratio of the parallel portion 150 and the serial portion 160 included in the electrode assembly 10 may be determined accordingly.

The parallel portion 150 of the electrode assembly 10 may be formed by winding or stacking a lamination of a first electrode, a first separator 120, and a second electrode, each of which has a thin plate or film geometry. Although not shown in FIG. 1, the first electrode may include a first substrate 130 disposed between a plurality of first positive electrode active material portions 132. The second electrode may include a second substrate 140 disposed between a plurality of first negative electrode active material portions 142.

In an embodiment, the electrode assembly 10 may be a stack-type electrode assembly 10 or a Z-stacked electrode assembly 10 in which the first electrode and the second electrode are inserted on both sides of a first separator 120 that is folded in a Z-stack configuration. Also, one or more such electrode assemblies 10 may be stacked so that their longitudinal sides are adjacent to each other and received in a case. The present disclosure does not limit the number of the electrode assemblies 10. In an embodiment, the electrode assembly 10 may include the first separator 120 and a first electrode and a second electrode positioned on both sides of the first separator 120 and be wound in a jelly-roll configuration.

The first electrode may be formed by coating a first positive electrode active material portion 132, such as a transition metal oxide, etc. on a first substrate 130 formed of a metal foil including aluminum or an aluminum alloy. The first electrode may include a first electrode tab (or a first uncoated portion), corresponding to a region where the first positive electrode active material portion 132 is not coated. The first electrode tab may be formed by cutting in advance to protrude to the other side when manufacturing the first electrode. The first electrode tab may protrude further to the other side than the first separator 120 without involving a separate cutting process.

The second electrode may be formed by coating a first negative electrode active material portion 142, such as graphite or carbon, on a second substrate 140 formed of a metal foil including copper, a copper alloy, nickel, or a nickel alloy. The second electrode may include a second electrode tab (or a second uncoated portion), corresponding to a region where the first negative electrode active material portion 142 is not coated. The second electrode tab may be formed in advance to protrude from one side when manufacturing the second electrode. The second electrode tab may protrude more than the first separator 120 without involving a separate cutting process.

The first separator 120 may allow lithium ions to migrate while preventing a short circuit that may happen between the first electrode and the second electrode. For example, the first separator 120 may include a polyethylene film, a polypropylene film, or a polyethylene-polypropylene film, but is not limited thereto.

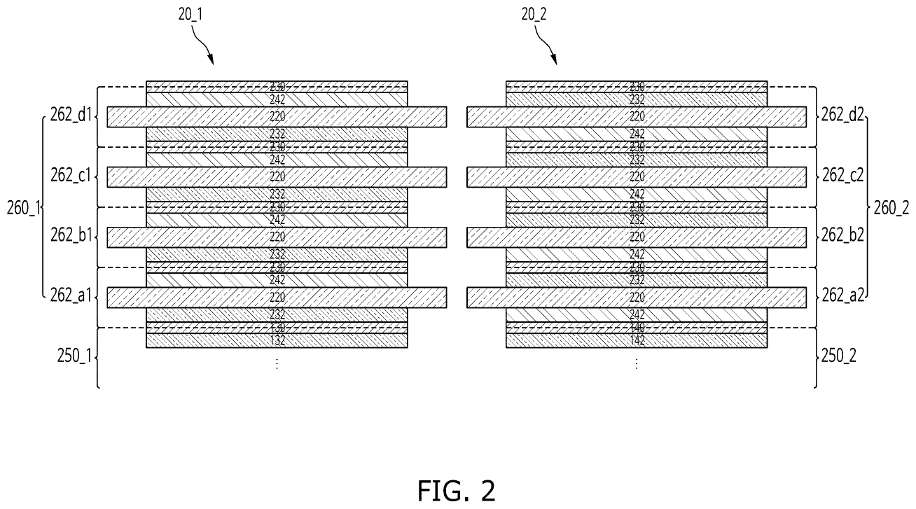

In an embodiment, the parallel portion 150 may be formed by stacking one or more first unit cells 152_a, 152_b. Each of the one or more first unit cells 152_a, 152_b may include: a first separator 120; a first positive electrode active material portion 132 disposed on one surface of the first separator 120; a first negative electrode active material portion 142 disposed on the other surface of the first separator 120; a first substrate 130 disposed on the first positive electrode active material portion 132; and a second substrate 140 disposed on the first negative electrode active material portion 142. The stacked one or more first unit cells 152_a, 152_b may share either the first substrate 130 having the first positive electrode active material portions 132 disposed on both surfaces thereof or the second substrate 140 having the first negative electrode active material portions 142 disposed on both surfaces thereof. In FIG. 1, the stacked first unit cells 152_a, 152_b are shown sharing the second substrate 140 on which the first negative electrode active material portions 142 are disposed on both surfaces, but the present disclosure is not limited thereto. An example in which the stacked first unit cells 152_a, 152_b share the first substrate 130 on which the first positive electrode active material portions 132 are disposed on both surfaces is described with reference to FIG. 2.

In FIG. 1, the parallel portion 150 is shown as being formed by stacking two first unit cells 152_a, 152_b, but is not limited thereto, and one or three or more unit cells may be stacked.

The serial portion 160 of the electrode assembly 10 may include a bipolar electrode and a second separator 220. The bipolar electrode may include a third substrate 230, a second positive electrode active material portion 232 disposed on one surface of the third substrate 230, and a second negative electrode active material portion 242 disposed on the other surface of the third substrate 230. A plurality of such bipolar electrodes may be stacked adjacent to each other or one another. The second separator 220 may be disposed between adjacent bipolar electrodes to electrically insulate the second positive electrode active material portion 232 and the second negative electrode active material portion 242. With the second separator 220 being in the center, the second positive electrode active material portion 232 and the second negative electrode active material portion 242 on both sides, along with the third substrate 230 on both sides, may form second unit cells 162_a, 162_b. That is, the serial portion 160 may have a structure formed by stacking a plurality of second unit cells 162_a, 162_b.

The third substrate 230 may have a plate geometry or a foil geometry. The third substrate 230 may include a material that does not react with lithium or does not form any alloy or compound with lithium. The third substrate 230 may include, for example, stainless steel, aluminum (Al), copper (Cu), titanium (Ti), iron (Fe), cobalt (Co), nickel (Ni), alloys thereof, clad materials thereof, etc., but is not necessarily limited thereto as long as it is used as a substrate for bipolar electrodes. For example, the third substrate 230 may include one of the enumerated metals, or an alloy or clad material including two or more of the enumerated metals.

The second positive electrode active material portion 232 disposed on one surface of the third substrate 230 may include a transition metal oxide. The second negative electrode active material portion 242 disposed on the other surface of the third substrate 230 may include graphite or carbon.

In an embodiment, the serial portion 160 may be formed by stacking one or more second unit cells 162_a, 162_b. Each of the one or more second unit cells 162_a, 162_b may include: a second separator 220; a second positive electrode active material portion 232 disposed on one surface of the second separator 220; a second negative electrode active material portion 242 disposed on the other surface of the second separator 220; and a third substrate 230 disposed on the second positive electrode active material portion 232 and the second negative electrode active material portion 242. The stacked one or more second unit cells 162_a, 162_b may share the third substrate 230 having the second positive electrode active material portion 232 disposed on one surface of the third substrate 230 and the second negative electrode active material portion 242 disposed on the other surface of the third substrate 230. The stacked second unit cells 162_a, 162_b may be connected in series inside the battery. The stacked second unit cells 162_a, 162_b may be connected in serial via the third substrate 230 inside the battery.

In FIG. 1, the serial portion 160 is shown to be formed by stacking two second unit cells 162_a, 162_b, but the present disclosure is not limited thereto. An example of a serial portion 160 formed by stacking two or more second unit cells 162_a, 162_b is described with reference to FIG. 2.

The serial portion 160 and the parallel portion 150 may share either the first substrate 130 having the first positive electrode active material portion 132 disposed on one surface and the second positive electrode active material portion 232 disposed on the other surface or the second substrate 140 having the first negative electrode active material portion 142 disposed on one surface and the second negative electrode active material portion 242 disposed on the other surface. In FIG. 1, the serial portion 160 and the parallel portion 150 are shown sharing the first substrate 130 having the first positive electrode active material portion 132 disposed on one surface and the second positive electrode active material portion 232 disposed on the other surface, but the present disclosure is not limited thereto. An example in which the serial portion 160 and the parallel portion 150 share the second substrate 140 having the first negative electrode active material portion 142 disposed on one surface and the second negative electrode active material portion 242 disposed on the other surface is described with reference to FIG. 2.

FIG. 2 is a cross-sectional view illustrating a serial portion 260. A first electrode assembly 20_1 may include a first parallel portion 250_1 and a first serial portion 260_1, and a second electrode assembly 20_2 may include a second parallel portion 250_2 and a second serial portion 260_2.

The serial portion 260 may be implemented in the form of the first serial portion 260_1 or the second serial portion 260_2. As shown in FIG. 2, the first serial portion 260_1 shares the first substrate 130 with the first parallel portion 250_1, where the first substrate 130 has the first positive electrode active material portion 132 disposed on one surface and the second positive electrode active material portion 232 disposed on the other surface. Meanwhile, the second serial portion 260_2 shares the second substrate 140 with the second parallel portion 250_2, where the second substrate 140 has the first negative electrode active material portion 142 disposed on one surface and the second negative electrode active material portion 242 disposed on the other surface.

Referring to FIG. 2, the serial portion 260 may be formed by stacking one or more second unit cells 262_a, 262_b, 262_c, 262_d. Each of the one or more second unit cells 262_a, 262_b, 262_c, 262_d may include: a second separator 220; a second positive electrode active material portion 232 disposed on one surface of the second separator 220; a second negative electrode active material portion 242 disposed on the other surface of the second separator 220; and a third substrate 230 respectively disposed on the second positive electrode active material portion 232 and the second negative electrode active material portion 242. The stacked one or more second unit cells 262_a, 262_b, 262_c, 262_d may share the third substrate 230 having the second positive electrode active material portion 232 disposed on one surface and the second negative electrode active material portion 242 disposed on the other surface.

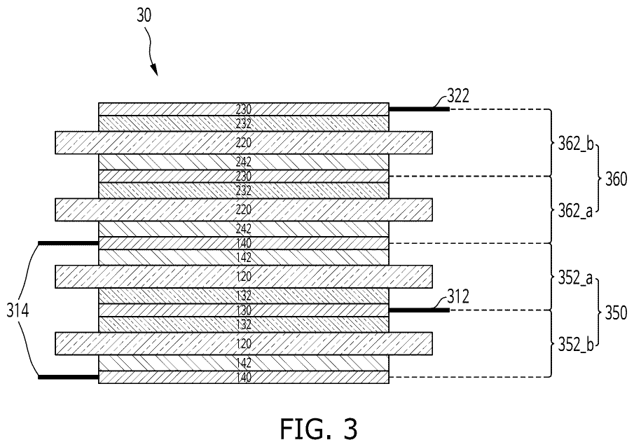

In an embodiment, the outermost layer of the serial portion 260 may include the third substrate 230. A second positive electrode active material portion 232 or a second negative electrode active material portion 242 may be disposed on one surface of the third substrate 230 that is positioned at the outermost side. The stacked second unit cells (262_a, 262_b, 262_c, 262_d) may be connected in series inside the battery. Specifically, the stacked second unit cells 262_a, 262_b, 262_c, 262_d may be connected in serial via the third substrate 230 inside the battery. Current generated in the serial portion 260 may move through the stacked bipolar electrodes to the outermost third substrate 230. An example of an electrode tab that delivers the collected current on the outermost third substrate 230 to the outside is described with reference to FIGS. 3 to 5.

The first serial portion 260_1 and the first parallel portion 250_1 may share the first substrate 130. For example, the first parallel portion 250_1 and the first serial portion 260_1 may share the first substrate 130 having the first positive electrode active material portion 132 disposed on one surface and the second positive electrode active material portion 232 disposed on the other surface.

The second serial portion 260_2 and the second parallel portion 250_2 may share the second substrate 140. For example, the second parallel portion 250_2 and the second serial portion 260_2 may share the second substrate 140 having the first negative electrode active material portion 142 disposed on one surface and the second negative electrode active material portion 242 disposed on the other surface.

In FIG. 2, the serial portion 260 is shown as being formed by stacking four second unit cells 262_a, 262_b, 262_c, 262_d, but the present disclosure is not limited thereto.

FIG. 3 is a cross-sectional view illustrating an electrode assembly 30 including an additional positive electrode tab 322.

Referring to FIG. 3, the electrode assembly 30 may include a parallel portion 350 and a serial portion 360.

The parallel portion 350 may be formed by stacking one or more first unit cells 352_a, 352_b. Each of the one or more first unit cells 352_a, 352_b may include: a first separator 120; a first positive electrode active material portion 132 disposed on one surface of the first separator 120; a first negative electrode active material portion 142 disposed on the other surface of the first separator 120; a first substrate 130 disposed on the first positive electrode active material portion 132; and a second substrate 140 disposed on the first negative electrode active material portion 142. Here, a positive electrode tab 312 may be disposed on the first substrate 130, and a negative electrode tab 314 may be disposed on the second substrate 140.

The serial portion 360 may be formed by stacking one or more second unit cells 362_a, 362_b. Each of the one or more second unit cells 362_a, 362_b may include: a second separator 220; a second positive electrode active material portion 232 disposed on one surface of the second separator 220; a second negative electrode active material portion 242 disposed on the other surface of the second separator 220; and a third substrate 230 disposed on the second positive electrode active material portion 232 and the second negative electrode active material portion 242.

Referring to FIG. 3, the third substrate 230 may be positioned at the outermost side of the serial portion 360. A second positive electrode active material portion 232 may be disposed on one surface of the third substrate 230 that is positioned at the outermost side. The stacked second unit cells 362_a, 362_b may be connected in series inside the battery. Specifically, the stacked second unit cells 362_a, 362_b may be connected in series via the third substrate 230 inside the battery. Current generated in the serial portion 360 moves through the stacked bipolar electrodes to the outermost third substrate 230. An additional positive electrode tab 322 may be disposed on the outermost third substrate 230.

Referring to FIG. 3, the parallel portion 350 and the serial portion 360 may share the second substrate 140. For example, the parallel portion 350 and the serial portion 360 may share the second substrate 140 having the first negative electrode active material portion 142 disposed on one surface and the second negative electrode active material portion 242 disposed on the other surface. A negative electrode tab 314 may be disposed on the second substrate 140 shared by the parallel portion 350 and the serial portion 360.

In FIG. 3, the parallel portion 350 is shown as being formed by stacking two first unit cells 352_a, 352_b, and the serial portion 360 is shown as being formed by stacking two second unit cells 362_a, 362_b, but the present disclosure is not limited thereto.

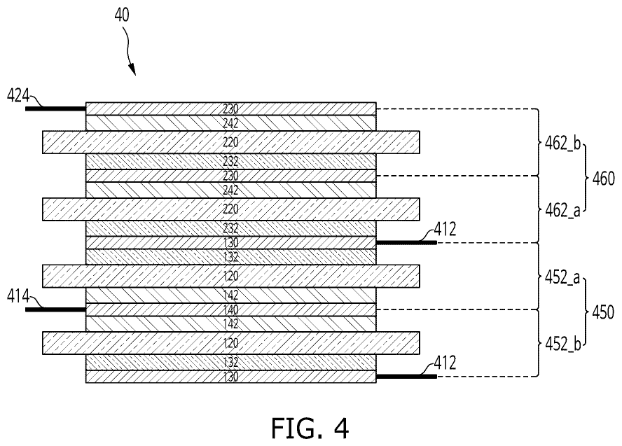

FIG. 4 is a cross-sectional view illustrating an electrode assembly 40 including an additional negative electrode tab 424.

Referring to FIG. 4, the electrode assembly 40 may include a parallel portion 450 and a serial portion 460.

The parallel portion 450 may be formed by stacking one or more first unit cells 452_a, 452_b. Each of the one or more first unit cells 452_a, 452_b may include: a first separator 120; a first positive electrode active material portion 132 disposed on one surface of the first separator 120; a first negative electrode active material portion 142 disposed on the other surface of the first separator 120; a first substrate 130 disposed on the first positive electrode active material portion 132; and a second substrate 140 disposed on the first negative electrode active material portion 142. Here, a positive electrode tab 412 may be disposed on the first substrate 130, and a negative electrode tab 414 may be disposed on the second substrate 140.

The serial portion 460 may be formed by stacking one or more second unit cells 462_a, 462_b. Each of the one or more second unit cells 462_a, 462_b may include: a second separator 220; a second positive electrode active material portion 232 disposed on one surface of the second separator 220; a second negative electrode active material portion 242 disposed on the other surface of the second separator 220; and a third substrate 230 disposed on the second positive electrode active material portion 232 and the second negative electrode active material portion 242.

Referring to FIG. 4, the third substrate 230 may be positioned at the outermost side of the serial portion 460. A second negative electrode active material portion 242 may be disposed on one surface of the third substrate 230 that is positioned at the outermost side. The stacked second unit cells 462_a, 462_b may be connected in series via the third substrate 230 inside the battery. Current generated in the serial portion 460 moves through the stacked bipolar electrodes to the outermost third substrate 230. An additional negative electrode tab 424 may be disposed on the outermost third substrate 230.

Referring to FIG. 4, the parallel portion 450 and the serial portion 460 may share the first substrate 130 having which the first positive electrode active material portion 132 disposed on one surface of the first substrate 130 and the second positive electrode active material portion 232 disposed on the other surface of the first substrate 130. A positive electrode tab 412 may be disposed on the first substrate 130 shared by the parallel portion 450 and the serial portion 460.

The number of the first unit cells 452_a, 452_b and the number of the second unit cells 462_a, 462_b are not limited to those shown in FIG. 4.

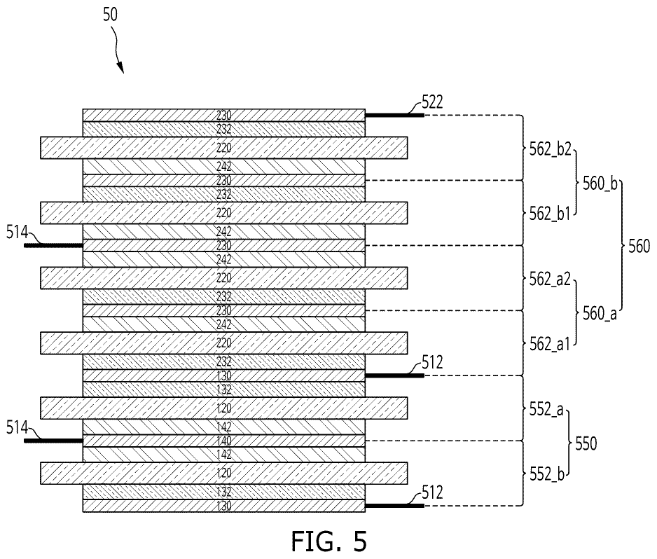

FIG. 5 is a cross-sectional view illustrating a plurality of serial portions 560_a, 560_b being stacked.

Referring to FIG. 5, the serial portion 560 may include a plurality of serial portions. For example, the serial portion 560 may include a first serial portion 560_a and a second serial portion 560_b.

A third substrate 230 may be positioned at the outermost side of the second serial portion 560_b. In FIG. 5, a second positive electrode active material portion 232 may be disposed on one surface of the third substrate 230 that is positioned at the outermost side. The stacked second unit cells 562_b1, 562_b2 may be connected in series via the third substrate 230 inside the battery. Current generated in the second serial portion 560_b moves through the stacked bipolar electrodes to the outermost third substrate 230. An additional positive electrode tab 522 may be disposed on the outermost third substrate 230.

In FIG. 5, the second positive electrode active material portion 232 is shown as being disposed on one surface of the outermost third substrate 230, but the present disclosure is not limited thereto. For example, a second negative electrode active material portion 242 may be disposed on one surface of the outermost third substrate 230, and an additional negative electrode tab may be disposed on the outermost third substrate 230.

Referring to FIG. 5, the first serial portion 560_a and the second serial portion 560_b may share the third substrate 230. For example, the first serial portion 560_a and the second serial portion 560_b may share the third substrate 230 having second negative electrode active material portions 242 disposed on both surfaces thereof. A negative electrode tab 514 may be disposed on the third substrate 230 shared by the first serial portion 560_a and the second serial portion 560_b. In FIG. 5, the first serial portion 560_a and the second serial portion 560_b are shown as sharing the third substrate 230 on which second negative electrode active material portions 242 are disposed on both surfaces, but the present disclosure is not limited thereto. For example, the first serial portion 560_a and the second serial portion 560_b may share the third substrate 230 on which second positive electrode active material portions 232 are disposed on both surfaces, and a positive electrode tab 512 may be disposed on the third substrate 230 shared by the first serial portion 560_a and the second serial portion 560_b.

The numbers of the first unit cells 552_a, 552_b and the second unit cells 562_a1, 562_a2, 562_b1, 562_b2 are not limited to those shown in FIG. 5.

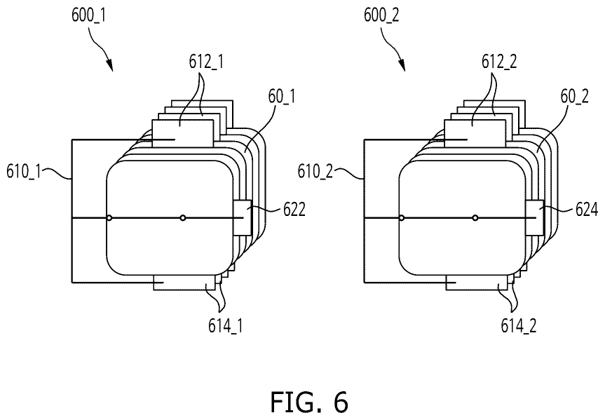

FIG. 6 shows a control circuit 610 being connected. A first example 600_1 shows a control circuit 610_1 being connected to a positive electrode tab 612_1, a negative electrode tab 614_1, and an additional positive electrode tab 622 in an electrode assembly 60_1 including the additional positive electrode tab 622, and a second example 600_2 shows a control circuit 610_2 being connected to a positive electrode tab 612_2, a negative electrode tab 614_2, and an additional negative electrode tab 624 in an electrode assembly 60_2 including the additional negative electrode tab 624.

In an embodiment, the secondary battery includes: an electrode assembly and a case accommodating the electrode assembly, wherein the case includes a positive electrode terminal and a negative electrode terminal. The electrode assembly includes a parallel portion formed by stacking one or more first unit cells and a serial portion formed by stacking one or more second unit cells. Each of the one or more first unit cells includes a first separator 120, a first positive electrode active material portion 132 disposed on one surface of the first separator 120, a first negative electrode active material portion 142 disposed on the other surface of the first separator 120, a first substrate 130 disposed on the first positive electrode active material portion 132, and a second substrate 140 disposed on the first negative electrode active material portion 142, and the stacked one or more first unit cells share either the first substrate 130 having the first positive electrode active material portions 132 disposed on both surfaces or the second substrate 140 having the first negative electrode active material portions 142 disposed on both surfaces. Each of the one or more second unit cells includes a second separator 220, a second positive electrode active material portion 232 disposed on one surface of the second separator 220, a second negative electrode active material portion 242 disposed on the other surface of the second separator 220, and a third substrate 230 respectively disposed on the second positive electrode active material portion 232 and the second negative electrode active material portion 242, and the stacked one or more second unit cells share the third substrate 230 having the second positive electrode active material portion 232 disposed on one surface and the second negative electrode active material portion 242 disposed on the other surface. The serial portion and the parallel portion may share either the first substrate 130 on which the first positive electrode active material portion 132 is disposed on one surface and the second positive electrode active material portion 232 is disposed on the other surface or the second substrate 140 having the first negative electrode active material portion 142 disposed on one surface of the second substrate 140 and the second negative electrode active material portion 242 disposed on the other surface of the second substrate 140.

In an embodiment, a positive electrode tab 612 may be disposed on the first substrate 130 of the parallel portion, and a negative electrode tab 614 may be disposed on the second substrate 140. For example, if the parallel portion and the serial portion share the second substrate 140 on which the first negative electrode active material portion 142 is disposed on one surface and the second negative electrode active material portion 242 is disposed on the other surface, the negative electrode tab 614 may be disposed on the shared second substrate 140. In an embodiment, if the parallel portion and the serial portion share the first substrate 130 on which the first positive electrode active material portion 132 is disposed on one surface and the second positive electrode active material portion 232 is disposed on the other surface, the positive electrode tab 612 may be disposed on the shared first substrate 130.

In the first example 600_1, the third substrate 230 may be positioned at the outermost side of the serial portion included in the electrode assembly 60_1. A second positive electrode active material portion 232 may be disposed on one surface of the third substrate 230 that is positioned at the outermost side, and an additional positive electrode tab 622 may be disposed on the outermost third substrate 230.

In the second example 600_2, the third substrate 230 may be positioned at the outermost side of the serial portion included in the electrode assembly 60_2. A second negative electrode active material portion 242 may be disposed on one surface of the third substrate 230 that is positioned at the outermost side, and an additional negative electrode tab 624 may be disposed on the outermost third substrate 230.

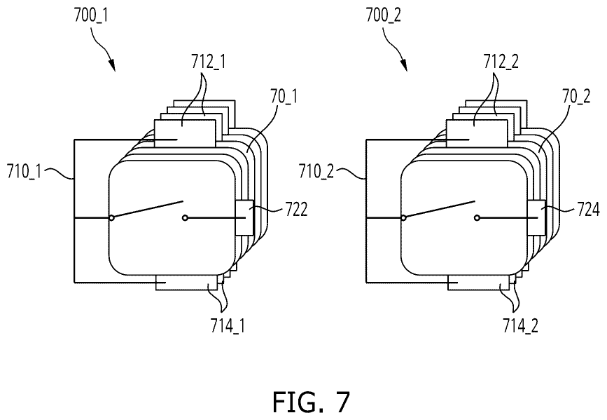

FIG. 7 shows a control circuit 710 being connected to the electrode assembly 70 until the SOC of the secondary battery reaches a predetermined reference SOC. A first example 700_1 shows, until the SOC of the secondary battery reaches the predetermined reference SOC, a control circuit 710_1 being connected to an electrode assembly 70_1 including an additional positive electrode tab 722. A second example 700_2 shows, until the SOC of the secondary battery reaches the predetermined reference SOC, a control circuit 710_2 being connected to an electrode assembly 70_2 including an additional negative electrode tab 724.

In the first example 700_1, the control circuit 710_1 may connect the positive electrode terminal to at least one of the positive electrode tab 712_1 or the additional positive electrode tab 722, and connect the negative electrode terminal to the negative electrode tab 714_1. For example, the control circuit 710_1 may connect the positive electrode terminal to the positive electrode tab 712_1 until the SOC of the secondary battery reaches a predetermined reference SOC, and the reference SOC may be from about 80% to about 130% based on the SOC of the secondary battery at a fully charged state. In the first example 700_1 shown in FIG. 7, the circuit connecting the positive electrode terminal and the additional positive electrode tab 722 is open, but the present disclosure is not limited thereto. For example, the control circuit 710_1 may connect the positive electrode terminal to both the positive electrode tab 712_1 and the additional positive electrode tab 722 until the SOC of the secondary battery reaches the predetermined reference SOC, and the reference SOC may be from about 80% to about 130% based on the SOC of the secondary battery at a fully charged state.

In the second example 700_2, the control circuit 710_2 may connect the positive electrode terminal to the positive electrode tab 712_2, and connect the negative electrode terminal to at least one of the negative electrode tab 714_2 or the additional negative electrode tab 724. For example, the control circuit 710_2 may connect the negative electrode terminal to the negative electrode tab 714_2 until the SOC of the secondary battery reaches a predetermined reference SOC, and the reference SOC may be from about 80% to about 130% based on the SOC of the secondary battery at a fully charged state. In the second example 700_2 shown in FIG. 7, the circuit connecting the negative electrode terminal and the additional negative electrode tab 724 is open, but the present disclosure is not limited thereto. For example, the control circuit 710_2 may connect the negative electrode terminal to both the negative electrode tab 714_2 and the additional negative electrode tab 724 until the SOC of the secondary battery reaches the predetermined reference SOC, and the reference SOC may be from about 80% to about 130% based on the SOC of the secondary battery at a fully charged state.

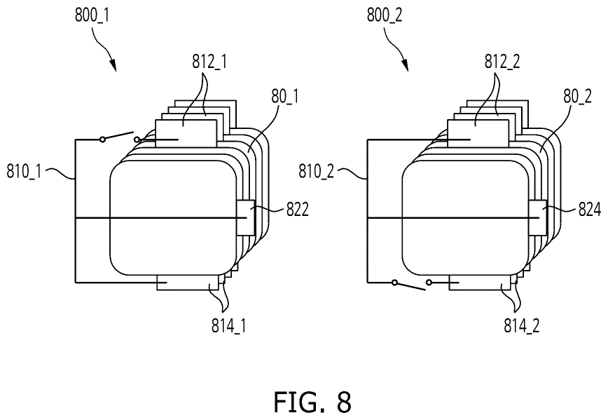

FIG. 8 shows a control circuit 810 being connected to the electrode assembly 80 after the SOC of the secondary battery reaches a predetermined reference SOC. A first example 800_1 shows, after the SOC of the secondary battery reaches the predetermined reference SOC, a control circuit 810_1 being connected to an electrode assembly 80_1 including an additional positive electrode tab 822. A second example 800_2 shows, after the SOC of the secondary battery reaches the predetermined reference SOC, a control circuit 810_2 being connected to an electrode assembly 80_2 including an additional negative electrode tab 824.

In the first example 800_1, the control circuit 810_1 may connect the positive electrode terminal to at least one of the positive electrode tab 812_1 or the additional positive electrode tab 822, and connect the negative electrode terminal to the negative electrode tab 814_1. For example, the control circuit 810_1 may connect the positive electrode terminal to the additional positive electrode tab 822 after the SOC of the secondary battery reaches a predetermined reference SOC, and the reference SOC may be from about 80% to about 130% based on the SOC of the secondary battery at a fully charged state. In the first example 800_1 shown in FIG. 8, the circuit connecting the positive electrode terminal and the positive electrode tab 812_1 is open, but the present disclosure is not limited thereto. For example, the control circuit 810_1 may connect the positive electrode terminal to both the positive electrode tab 812_1 and the additional positive electrode tab 822 after the SOC of the secondary battery reaches the predetermined reference SOC, and the reference SOC may be from about 80% to about 130% based on the SOC of the secondary battery at a fully charged state.

In the second example 800_2, the control circuit 810_2 may connect the positive electrode terminal to the positive electrode tab 812_2, and connect the negative electrode terminal to at least one of the negative electrode tab 814_2 or the additional negative electrode tab 824. For example, the control circuit 810_2 may connect the negative electrode terminal to the additional negative electrode tab 824 after the SOC of the secondary battery reaches a predetermined reference SOC, and the reference SOC may be from about 80% to about 130% based on the SOC of the secondary battery at a fully charged state. In the second example 800_2 shown in FIG. 8, the circuit connecting the negative electrode terminal and the negative electrode tab 814_2 is open, but the present disclosure is not limited thereto. For example, the control circuit 810_2 may connect the negative electrode terminal to both the negative electrode tab 814_2 and the additional negative electrode tab 824 after the SOC of the secondary battery reaches the predetermined reference SOC, and the reference SOC may be from about 80% to about 130% based on the SOC of the secondary battery at a fully charged state.

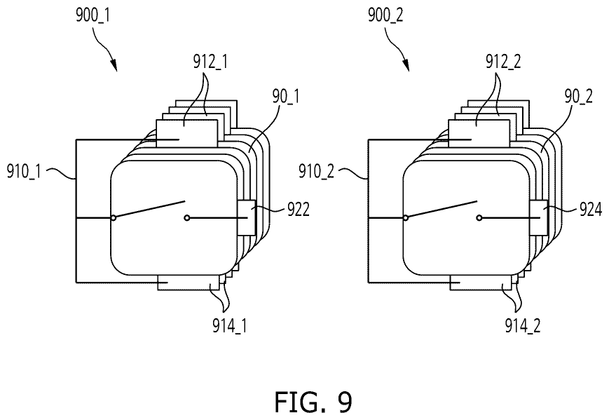

FIG. 9 shows a control circuit 910 being connected to the electrode assembly 90 until an internal voltage of the secondary battery reaches a predetermined cut-off voltage. A first example 900_1 shows, until the internal voltage of the secondary battery reaches the predetermined cut-off voltage, a control circuit 910_1 being connected to an electrode assembly 90_1 including an additional positive electrode tab 922. A second example 900_2 shows, until the internal voltage of the secondary battery reaches the predetermined cut-off voltage, a control circuit 910_1 being connected to an electrode assembly 90_2 including an additional negative electrode tab 924.

In the first example 900_1, the control circuit 910_1 may connect the positive electrode terminal to at least one of the positive electrode tab 912_1 or the additional positive electrode tab 922, and connect the negative electrode terminal to the negative electrode tab 914_1. For example, the control circuit 910_1 may connect the positive electrode terminal to the positive electrode tab 912_1 until the internal voltage of the secondary battery reaches a predetermined cut-off voltage, and the cut-off voltage may be from about 4.25V to about 4.3V. In the first example 900_1 shown in FIG. 9, the circuit connecting the positive electrode terminal and the additional positive electrode tab 922 is open, but the present disclosure is not limited thereto. For example, the control circuit 910_1 may connect the positive electrode terminal to both the positive electrode tab 912_1 and the additional positive electrode tab 922 until the internal voltage of the secondary battery reaches the predetermined cut-off voltage, and the cut-off voltage may be from about 4.25V to about 4.3V.

In the second example 900_2, the control circuit 910_2 may connect the positive electrode terminal to the positive electrode tab 912_2, and connect the negative electrode terminal to at least one of the negative electrode tab 914_2 or the additional negative electrode tab 924. For example, the control circuit 910_2 may connect the negative electrode terminal to the negative electrode tab 914_2 until the internal voltage of the secondary battery reaches a predetermined cut-off voltage, and the cut-off voltage may be from about 4.25V to about 4.3V. In the second example 900_2 shown in FIG. 9, the circuit connecting the negative electrode terminal and the additional negative electrode tab 924 is open, but the present disclosure is not limited thereto. For example, the control circuit 910_2 may connect the negative electrode terminal to both the negative electrode tab 914_2 and the additional negative electrode tab 924 until the internal voltage of the secondary battery reaches the predetermined cut-off voltage, and the cut-off voltage may be from about 4.25V to about 4.3V.

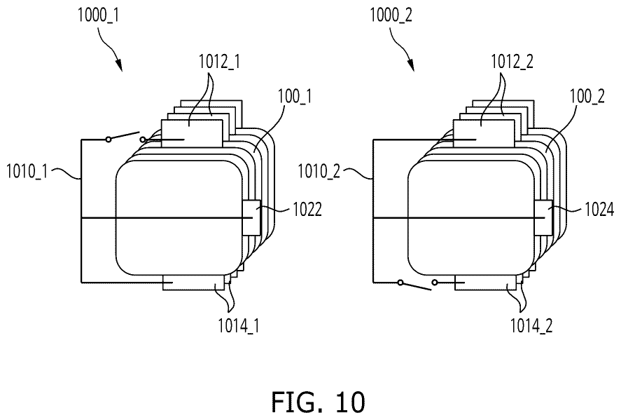

FIG. 10 shows a control circuit 1010 being connected to the electrode assembly 100 after the internal voltage of the secondary battery reaches a predetermined cut-off voltage. A first example 1000_1 shows, after the internal voltage of the secondary battery reaches the predetermined cut-off voltage, a control circuit 1010_1 being connected to an electrode assembly 100_1 including an additional positive electrode tab 1022. A second example 1000_2 shows, after the internal voltage of the secondary battery reaches the predetermined cut-off voltage, a control circuit 1010_2 being connected to an electrode assembly 100_2 including an additional negative electrode tab 1024.

In the first example 1000_1, the control circuit 1010_1 may connect the positive electrode terminal to at least one of the positive electrode tab 1012_1 or the additional positive electrode tab 1022, and connect the negative electrode terminal to the negative electrode tab 1014_1. For example, the control circuit 1010_1 may connect the positive electrode terminal to the additional positive electrode tab 1022 after the internal voltage of the secondary battery reaches a predetermined cut-off voltage, and the cut-off voltage may be from about 4.25V to about 4.3V. In the first example 1000_1 shown in FIG. 10, the circuit connecting the positive electrode terminal and the positive electrode tab 1012_1 is open, but the present disclosure is not limited thereto. For example, the control circuit 1010_1 may connect the positive electrode terminal to both the positive electrode tab 1012_1 and the additional positive electrode tab 1022 after the internal voltage of the secondary battery reaches the predetermined cut-off voltage, and the cut-off voltage may be from about 4.25V to about 4.3V.

In the second example 1000_2, the control circuit 1010_2 may connect the positive electrode terminal to the positive electrode tab 1012_2, and connect the negative electrode terminal to at least one of the negative electrode tab 1014_2 or the additional negative electrode tab 1024. For example, the control circuit 1010_2 may connect the negative electrode terminal to the additional negative electrode tab 1024 after the internal voltage of the secondary battery reaches a predetermined cut-off voltage, and the cut-off voltage may be from about 4.25V to about 4.3V. In the second example 1000_2 shown in FIG. 10, the circuit connecting the negative electrode terminal and the negative electrode tab 1014_2 is open, but the present disclosure is not limited thereto. For example, the control circuit 1010_2 may connect the negative electrode terminal to both the negative electrode tab 1014_2 and the additional negative electrode tab 1024 after the internal voltage of the secondary battery reaches the predetermined cut-off voltage, and the cut-off voltage may be from about 4.25V to about 4.3V.

Although the present disclosure has been described above with respect to embodiments thereof, the present disclosure is not limited thereto. Various modifications and variations can be made thereto by those skilled in the art within the spirit of the present disclosure.

What is claimed is:

1. A battery electrode assembly comprising:
a parallel portion comprising one or more first unit cells being stacked; and
a serial portion comprising one or more second unit cells being stacked,
wherein each of the one or more first unit cells comprises:
a first separator;
a first positive electrode active material portion disposed on one surface of the first separator;
a first negative electrode active material portion disposed on the other surface of the first separator;
a first substrate disposed on the first positive electrode active material portion; and
a second substrate disposed on the first negative electrode active material portion,
wherein the one or more first unit cells being stacked share either the first substrate having the first positive electrode active material portion disposed on both surfaces of the first substrate, or the second substrate having the first negative electrode active material portion disposed on both surfaces of the second substrate,
wherein each of the one or more second unit cells comprises:
a second separator;
a second positive electrode active material portion disposed on one surface of the second separator;
a second negative electrode active material portion disposed on the other surface of the second separator; and
a third substrate disposed on the second positive electrode active material portion and the second negative electrode active material portion, and
wherein the one or more second unit cells being stacked share the third substrate having the second positive electrode active material portion disposed on one surface of the third substrate and the second negative electrode active material portion disposed on the other surface of the third substrate, and
wherein the serial portion and the parallel portion share either the first substrate having the first positive electrode active material portion disposed on one surface of the first substrate and the second positive electrode active material portion disposed on the other surface of the first substrate, or the second substrate having the first negative electrode active material portion disposed on one surface of the second substrate and the second negative electrode active material portion disposed on the other surface of the second substrate.

2. The battery electrode assembly according to claim 1, further comprising:
a positive electrode tab disposed on the first substrate; and
a negative electrode tab disposed on the second substrate.

3. The battery electrode assembly according to claim 2, wherein a second positive electrode active material portion is disposed on an inner surface of the third substrate positioned at an outermost side of the serial portion, and wherein an additional positive electrode tab is disposed on the third substrate positioned at the outermost side.

4. The battery electrode assembly according to claim 2, wherein a second negative electrode active material portion is disposed on an inner surface of the third substrate positioned at an outermost side of the serial portion, and wherein an additional negative electrode tab is disposed on the third substrate positioned at the outermost side.

5. The battery electrode assembly according to claim 1, wherein a ratio (C1/C2) of a charge capacity (C1) of the serial portion to a total charge capacity (C2) of the serial portion and the parallel portion is from about 0.05 to about 0.25.

6. A secondary battery comprising:
an electrode assembly; and
a case accommodating the electrode assembly,
wherein the case includes a positive electrode terminal and a negative electrode terminal,
wherein the electrode assembly comprises:
a parallel portion comprising one or more first unit cells being stacked; and
a serial portion comprising one or more second unit cells being stacked,
wherein each of the one or more first unit cells comprises:
a first separator;
a first positive electrode active material portion disposed on one surface of the first separator;
a first negative electrode active material portion disposed on the other surface of the first separator;
a first substrate disposed on the first positive electrode active material portion; and
a second substrate disposed on the first negative electrode active material portion,
wherein the one or more first unit cells being stacked share either the first substrate having the first positive electrode active material portion disposed on both surfaces of the first substrate, or the second substrate having the first negative electrode active material portion disposed on both surfaces of the second substrate,
wherein each of the one or more second unit cells comprises:
a second separator;
a second positive electrode active material portion disposed on one surface of the second separator;
a second negative electrode active material portion disposed on the other surface of the second separator; and
a third substrate disposed on the second positive electrode active material portion and the second negative electrode active material portion, and
wherein the one or more second unit cells being stacked share the third substrate having the second positive electrode active material portion disposed on one surface of the third substrate and the second negative electrode active material portion disposed on the other surface of the third substrate, and
wherein the serial portion and the parallel portion share either the first substrate having the first positive electrode active material portion disposed on one surface of the first substrate and the second positive electrode active material portion disposed on the other surface of the first substrate, or the second substrate having the first negative electrode active material portion disposed on one surface of the second substrate and the second negative electrode active material portion disposed on the other surface of the second substrate.

7. The secondary battery according to claim 6, wherein the electrode assembly further comprises:
a positive electrode tab disposed on the first substrate; and
a negative electrode tab disposed on the second substrate.

8. The secondary battery according to claim 7, wherein a second positive electrode active material portion is disposed on an inner surface of the third substrate positioned at an outermost side of the serial portion, and wherein an additional positive electrode tab is disposed on the third substrate positioned at the outermost side.

9. The secondary battery according to claim 8, further comprising a control circuit configured to connect the positive electrode terminal to at least one of the positive electrode tab or the additional positive electrode tab, and to connect the negative electrode terminal to the negative electrode tab.

10. The secondary battery according to claim 9, wherein the control circuit is configured to connect the positive electrode terminal to the positive electrode tab until a state of charge (SOC) of the secondary battery reaches a reference SOC, and wherein the reference SOC is from about 80% to about 130% based on the SOC of the secondary battery at a fully charged state.

11. The secondary battery according to claim 9, wherein the control circuit is configured to connect the positive electrode terminal to the additional positive electrode tab upon a state of charge (SOC) of the secondary battery reaching a reference SOC, and wherein the reference SOC is from about 80% to about 130% based on the SOC of the secondary battery at a fully charged state.

12. The secondary battery according to claim 9, wherein the control circuit is configured to connect the positive electrode terminal to the positive electrode tab until an internal voltage of the secondary battery reaches a cut-off voltage, and wherein the cut-off voltage is from about 4.25V to about 4.3V.

13. The secondary battery according to claim 9, wherein the control circuit is configured to connect the positive electrode terminal to the additional positive electrode tab upon an internal voltage of the secondary battery reaching a cut-off voltage, and wherein the cut-off voltage is from about 4.25V to about 4.3V.

14. The secondary battery according to claim 7, wherein a second negative electrode active material portion is disposed on an inner surface of the third substrate positioned at an outermost side of the serial portion, and wherein an additional negative electrode tab is disposed on the third substrate positioned at the outermost side.

15. The secondary battery according to claim 14, further comprising a control circuit configured to connect the positive electrode terminal to the positive electrode tab, and connect the negative electrode terminal to at least one of the negative electrode tab or the additional negative electrode tab.

16. The secondary battery according to claim 15, wherein the control circuit is configured to connect the negative electrode terminal to the negative electrode tab until a state of charge (SOC) of the secondary battery reaches a reference SOC, and wherein the reference SOC is from about 80% to about 130% based on the SOC of the secondary battery at a fully charged state.

17. The secondary battery according to claim 15, wherein the control circuit is configured to connect the negative electrode terminal to the additional negative electrode tab upon a state of charge (SOC) of the secondary battery reaching a reference SOC, and wherein the reference SOC is from about 80% to about 130% based on the SOC of the secondary battery at a fully charged state.

18. The secondary battery according to claim 15, wherein the control circuit is configured to connect the negative electrode terminal to the negative electrode tab until an internal voltage of the secondary battery reaches a cut-off voltage, and wherein the cut-off voltage is from about 4.25V to about 4.3V.

19. The secondary battery according to claim 15, wherein the control circuit is configured to connect the negative electrode terminal to the additional negative electrode tab upon an internal voltage of the secondary battery reaching a cut-off voltage, and wherein the cut-off voltage is from about 4.25V to about 4.3V.

20. The secondary battery according to claim 6, wherein a ratio (C1/C2) of a charge capacity (C1) of the serial portion to a total charge capacity (C2) of the serial portion and the parallel portion is from about 0.05 to about 0.25.
